(19) United States
(12) Patent Application Publication
(10) Pub. No.: US 2006/0130653 A1
(43) Pub. Date: Jun. 22, 2006

(54) Smoke collector for diesel engines

(76) Inventor: Ronald F. Balingit, Agoura Hills, CA (US)

Correspondence Address: Ronald F. Balingit, 6320 Meadow Haven Drive, Agoura Hills, CA, 91301, US

(21) Appl. No.: 10/783,224

(22) Filed: Feb. 20, 2004

(51) Int. Cl. B01D 53/14

(52) U.S. Cl. 95/216

(57) ABSTRACT

A process for removing extremely fine and sticky particles, such as smoke, from gas streams comprising the steps of: increasing the relative humidity of the gas and compelling the gas to interact with a cold solid surface. This invention is most suitable for removing smoke from the exhaust gas of vehicular Diesel engines because it can have a low water usage and the components can replace the muffler for noise reduction, thereby avoiding any significant increase of engine back pressure. In addition, the components of this invention will not require a large space for installation and can be made to fit on the vehicle.

### BACKGROUND OF THE INVENTION

A. Field of the Invention

This invention relates to particulate collectors, specifically to a smoke collector for removing smoke from the exhaust gas of Diesel engines.

B. Description of the Prior Art

Prior art particulate collectors can be classified using their principle of operation. One possible classification is: inertial, electrical, mechanical and wet. Some prior art particulate collectors use combinations of these principles to enhance particulate collection.

The self-cleaning smoke filter by Hartwick, U.S. Pat. No. 4,061,478, uses the wet principle. The integrated injection and bag filter house system by Doyle, et al., U.S. Pat. No. 4,793,981, uses the mechanical principle. The cyclonic separator by Richerson, U.S. Pat. No. 4,927,437, uses the combination of the inertial and electrical principles. The electrostatically enhanced separator by Altman, et al., U.S. Pat. No. 5,683,494, uses the combination of the inertial and electrical principles. The particulate collector by Paul, et al., U.S. Pat. No. 4,239,513, uses the combination of the inertial and wet or electrical principles.

The following describes representative particulate collectors using the principles and their disadvantages when used for removing smoke from the exhaust gas of Diesel engines.

Under inertial is the cyclone which separates heavy particles from light particles by centrifugal forces. Due to the size and weight of smoke particles, it will require extremely high velocities to create the necessary centrifugal forces and an extremely long cyclone to remove smoke from the gas. If one can be made for such application, such a cyclone will cause excessive engine back pressure which will reduce engine power output and can cause engine failure. In addition, fouling of the surfaces due to the stickiness of the smoke particles will also increase engine back pressure and will require forced shutdowns for cleaning.

Under electrical is the electrostatic precipitator which removes particulates from a gas stream by using electrostatic forces. Using electrodes or wires, the particulates are given an electrostatic charge, then the charged particulates are passed near oppositely charged plates. Electrostatic forces will cause the charged particulates to collect on the plates. Rapping or shaking the plates will cause the collected particulates to drop to a storage hopper. The velocity of the gas is kept low to minimize re entrainment of collected particulates into the gas stream. Due to this requirement, electrostatic precipitators are usually installed inside large structures. Due to the stickiness of smoke in the exhaust gas of Diesel engines, fouling of the discharge electrodes and collection plates will occur. Rapping and shaking will not be sufficient and forced shutdowns will be necessary for cleaning.

Under mechanical is the bag filter which mechanically screens the particulates out of the gas stream. Due to the size of smoke particles, it is doubtful that a bag filter can be made that will not plug up after a brief period of operation. Even if such a bag filter can be made, the stickiness of the smoke particles in the exhaust gas of Diesel engines will make on line cleaning methods, such as shaking, ineffective and forced shutdowns will be necessary for bag cleaning or replacement. The greatest disadvantage of the bag filter is the excessive increase in engine back pressure which will cause loss of power output and can cause engine failure.

Under wet is the wet scrubber which collects particulates from a gas stream by passing the gas stream through water sprays, curtains of water or combinations of the two. The general idea is to capture the particulates that come in contact with the water surface. For a scrubber that recycles the water, water make up is necessary to replace the water evaporated and carried away by the gas stream. For high temperature gas streams, such as the exhaust gas of Diesel engines, the water make up can be excessive. In general, wet scrubbers using water sprays or water curtains will have this disadvantage.

Although the field of particulate collectors is wide, the principles of operation covered and the disadvantages identified for Diesel engine exhaust gas application should be general enough to encompass the entire field.

In conclusion, there is no particulate collector in the prior art that is practical for removing smoke from the exhaust gas of Diesel engines.

### SUMMARY OF THE INVENTION

A. Objects and Advantages

This invention will provide a smoke collector for Diesel engines:

a) which will not cause excessive engine back pressure,

b) which will not require forced shutdowns for cleaning fouled surfaces,

c) which will not require a large enclosure, and

d) which will not require excessive water makeup.

This invention will also provide a smoke collector for Diesel engines:

a) which is inexpensive to manufacture,

b) which can replace the existing mufflers of the engines,

c) whose shape and dimensions can be made to satisfy a specific application,

d) which will make the stickiness of the smoke an asset for effective smoke collection, and

e) which will reduce air pollution for the benefit of the public and the environment.

Further objects and advantages of this invention will become apparent from a consideration of the drawings and ensuing description.

B. Description of the Invention

This invention is a process for removing particulates from a gas stream comprising the steps of:

a) increasing the relative humidity of the gas stream, and

b) compelling the gas stream to interact with a solid surface whose temperature does not exceed the dew point temperature of the gas stream.

Control of the process is achieved by:

a) controlling the increase in relative humidity of the gas stream,

b) controlling the movement of the gas stream to force the gas stream to flow near said solid surface,

c) controlling the rate of cooling of said solid surface to keep the temperature of said solid surface from exceeding the dew point temperature of the gas steam, and

d) controlling the cleanliness of said solid surface by removing collected particulates and condensate from said solid surface.

C. Material of the Invention

Due to the corrosiveness of the condensate, especially with Diesel engine exhaust gas which often contains sulfur compounds, it is necessary to use materials which can withstand that corrosiveness.

Materials commonly used in the industry to withstand corrosiveness include: glass, porcelain, stainless steel for making mufflers and exhaust pipes of vehicles, enamel-covered mild steel commonly used in the manufacture of air preheater baskets of regenerative air preheaters of steam generators, and cast iron or mild steel coated with a material used in the manufacture of household pots and pans.

For the components that will not come in contact with the condensate, ordinary materials such as cast iron and mild steel can be used.

### DRAWINGS OF THE INVENTION

A. Brief Description of the Drawings

FIG. 1 is a schematic drawing of the particulate collection process.

FIG. 2 is cross section of one embodiment of the particulate trapper.

FIG. 3 is an isometric drawing, with one face of the enclosure removed, of another embodiment of the particulate trapper.

B. List of Reference Numerals

1—inlet means

2—enclosure

3—outlet means

4—solid surface

5—cooling means

6—cleaning means

7—opening for conveyance of condensate and particulates

C. Detailed Description of the Drawings

This invention is a process for removing particulates from a gas stream using common devices and a new device that operates under a new concept.

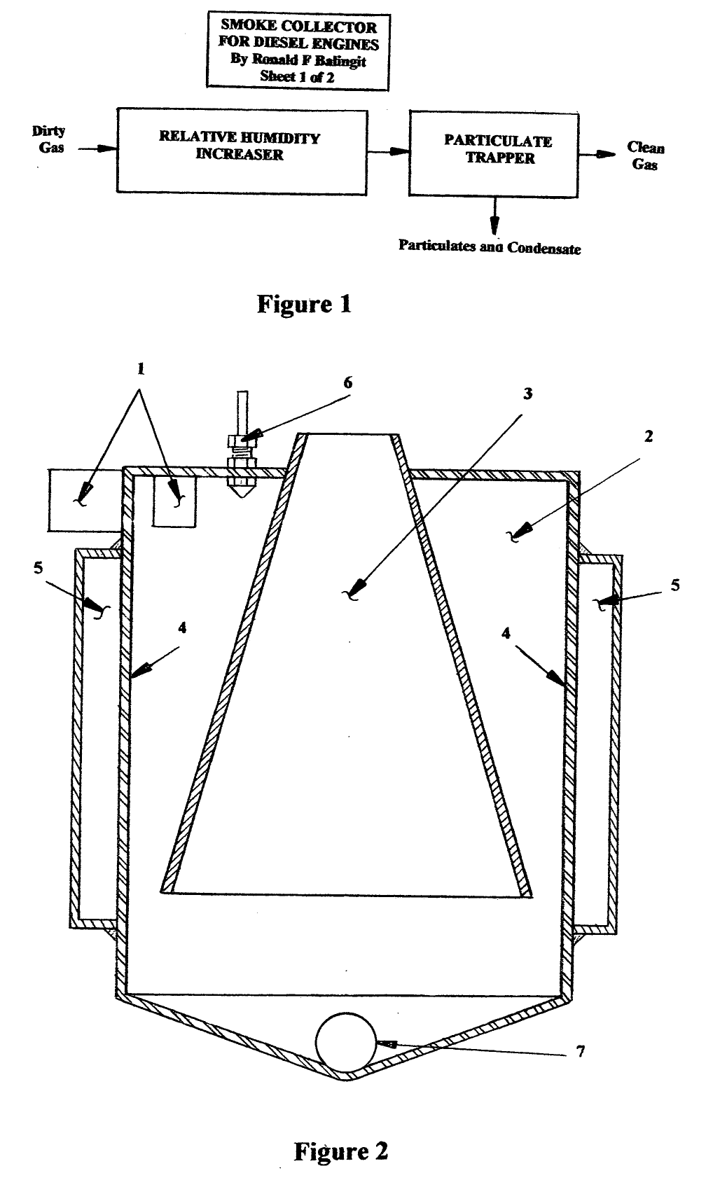

FIG. 1 shows a schematic drawing of said process.

The two basic components of said process are: a Relative Humidity Increaser and a Particulate Trapper.

The gas stream containing the particulates to be removed is referred to as dirty gas and the gas stream leaving said Particulate Trapper is referred to as clean gas in FIG. 1. The following describes the basic components of said process.

Relative Humidity Increaser

The relative humidity of the dirty gas can be increased by any of the following methods:

a) Cooling the gas with a heat exchanger, if water vapor is present in the gas.

b) Injecting water into the gas.

c) Injecting steam into the gas, provided the steam will not cause a significant increase in gas temperature.

d) Combinations of the above methods.

These methods can be controlled to limit the increase in the relative humidity of the dirty gas.

Heat exchangers, water injection systems and steam injection systems are common in the industry and can be designed and manufactured using known engineering principles and manufacturing processes, respectively.

Factors affecting the selection of an embodiment of said Relative Humidity Increaser include:

a) dirty gas temperature,

b) water vapor content of dirty gas,

c) dirty gas pressure drop across the embodiment,

d) vehicular or stationary application,

e) available space for installation,

f) water usage,

g) regulatory requirements, and

h) economics.

For example, very hot exhaust gas from a vehicular Diesel engine may use water injection as the most economical option, but, since plentiful water is impractical to carry on the vehicle, a heat exchanger may be required. The gas pressure drop across the combination will increase the engine back pressure and will result in loss of power output of the engine. The available space for installation will determine the size and shape of the heat exchanger. Optimization can be used to select an embodiment of said Relative Humidity Increaser that will satisfy any regulatory requirements.

If the Diesel engine in the above example is for stationary service, the factors that will change the optimization are water usage and available space for installation, both of which can be greater than those for the vehicular Diesel engine.

If the exhaust muffler is replaced by the components of this invention, the loss of power cost will change in the above examples.

As an another example, cold gas with a high relative humidity from an industrial process will not require a complicated analysis because a Relative Humidity Increaser may not be necessary. In this example, a simple water injection can be used as a control trim to cover rapid drops in the relative humidity of the gas, if such a control trim is desired.

Evidently, an embodiment of said Relative Humidity Increaser for a specific application of this invention will be determined by the above factors and cannot be described with specificity here.

Particulate Trapper

A Particulate Trapper comprising:

a) said solid surface inside an enclosure,

b) said enclosure with an inlet means for admitting the dirty gas from said Relative Humidity Increaser and an outlet means for allowing clean gas to exit said enclosure,

c) a cooling means for keeping the temperature of said solid surface from exceeding the dew point temperature of the dirty gas, and

d) a cleaning means for removing collected particulates and condensate from said solid surface.

The elements composing said Particulate Trapper can be embodied in several ways. For this reason said Particulate Trapper can have numerous embodiments.

Said solid surface can be planar, cylindrical, other geometric shapes or combinations of geometric shapes.

Said enclosure can be a parallelepiped, cylindrical, other geometric shapes or combinations of geometric shapes.

Said cooling means can be cooling fins for natural draft or forced draft air cooling, a water jacket with a separate radiator, a water jacket connected to an existing radiator, a water jacket cooled by a refrigerant, and direct cooling with a refrigerant.

Said cleaning means can be a water spray inside said enclosure, positively driven scrapers or wipers inside said enclosure or a combination of the two.

To provide some specificity and to help visualize the concept of particulate collection, the following will be used here.

A vertical cylinder sheet covered at both ends as an embodiment of said enclosure.

The inside wall of said vertical cylinder sheet as an embodiment of said solid surface.

A rectangular tube with one face tangential to said solid surface as an embodiment of said inlet means.

A conical section sheet located inside and coaxial with said vertical cylinder sheet with the smaller end of said conical section sheet connected to the top cover of said vertical cylinder sheet as an embodiment of said outlet means.

A water jacket on the outside of said vertical cylinder sheet as an embodiment of said cooling means.

A water spray inside said enclosure as an embodiment of said cleaning means.

FIG. 2 shows a cross section, along the axis of said vertical cylinder sheet, as the embodiment of said Particulate Trapper with these elements.

Using FIG. 2, particulate collection is described below.

Dirty gas enters enclosure 2 through inlet means 1. Once inside, the gas will revolve around outlet means 3 and will come in contact with solid surface 4. Because the temperature of solid surface 4 will not exceed the dew point temperature of the gas, water vapor will condense on solid surface 4. Particulates coming in contact with the condensate will be trapped. More particulates will be trapped as more condensate forms on solid surface 4 and on the particulates already trapped there. This can be called the “fly-trap” effect. Sticky particulates, such as smoke particles in the exhaust gas of Diesel engines will cohere to smoke particles already trapped on solid surface 4, thereby enhancing the fly-trap effect.

As water vapor condenses on solid surface 4 and on the trapped particulates, the partial pressure of water vapor near solid surface 4 will decrease creating localized spaces near solid surface 4 with a lower total pressure, as defined by Dalton's law, than the main gas stream. This lower total pressure will create a potential for the main gas stream to flow toward solid surface 4.

As the gas spirals toward the bottom of enclosure 2, the gas is forced to move closer and closer to solid surface 4 by outlet means 3, thereby increasing the chance for capture of more particulates.

Clean gas exits through the opening at the bottom of outlet means 3. Because the opening at the bottom is bigger than the opening at the top, reentrainment of collected particulates is minimized. Outlet means 3 provides two beneficial roles: to force the gas to move closer to solid surface 4 and to minimize reentrainment of collected particulates.

Cooling means 5 will transfer heat from solid surface 4 to the surroundings. The rate of heat transfer will be controlled to ensure that the temperature of solid surface 4 will not exceed the dew point temperature of the dirty gas.

Cleaning means 6 will remove condensate and trapped particulates from solid surface 4 and convey the material removed to the bottom of enclosure 2 for storage or disposal. The mode of operation of cleaning means 6 will be controlled to ensure a sufficient area of solid surface 4 is relatively clean at all times.

Compelling the gas stream to interact with solid surface 4 is achieved by: admitting the gas into enclosure 2, creating localized low pressure spaces near solid surface 4, and forcing the gas to move closer and closer to solid surface 4.

An opening, marked 7, in FIG. 2 is for allowing the conveyance of particulates and condensate from said Particulate Trapper to a separate storage container.

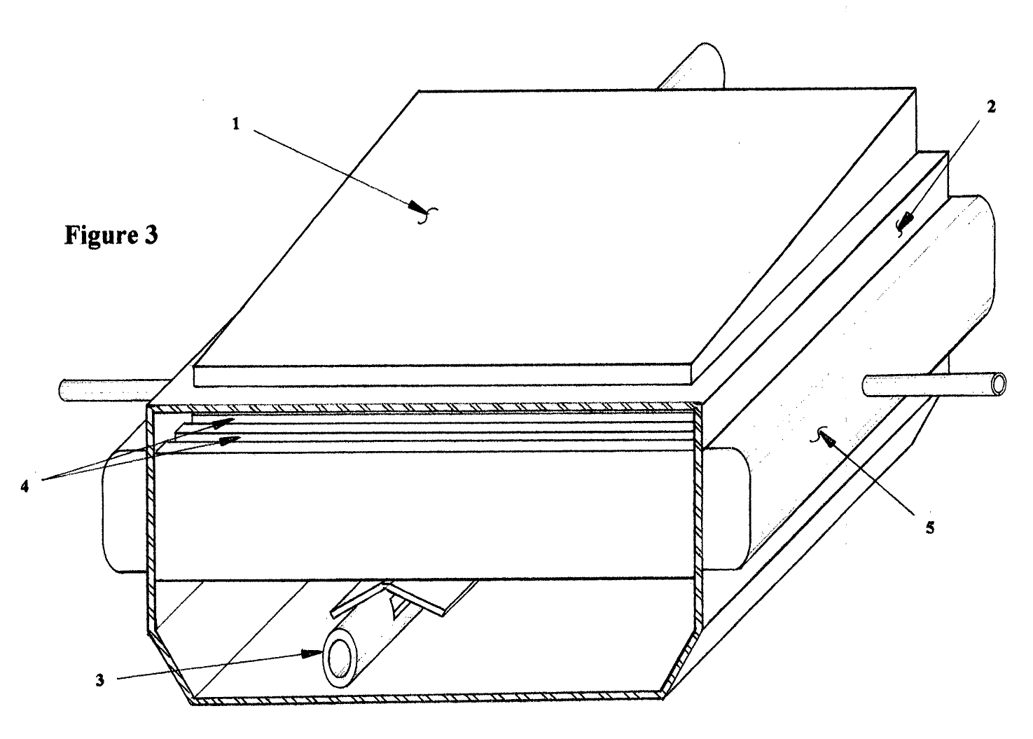

FIG. 3 is an isometric drawing of another embodiment of said Particulate Trapper with one face of said enclosure removed to show the internal elements. This embodiment shows, among other things, water-cooled plates making up said solid surface, an inlet header to distribute the dirty gas evenly across the plates as said inlet means, and a box-like enclosure.

The name Smoke Collector for Diesel Engines of this invention was used to emphasize the ability of this invention to collect extremely fine and sticky particles, such as smoke in the exhaust gas of Diesel engines, and should not limit the application of this invention. This Smoke Collector for Diesel Engines can be used to remove water vapor and particulates from any gas stream whether or not smoke is present.

Other Applications of Particulate Trapper

Fossil-fueled Power Plants: Water vapor and particulate collector at the back end of a wet flue gas scrubber to improve plume appearance, to reduce flue gas reheat requirement and to reduce induced-draft fan power requirement.

Air Conditioning Pretreatment: Water vapor and smoke collector to reduce the latent heat load of the air conditioning system.

I claim:

1. A process for removing particulates from a gas stream comprising the steps of:
a) increasing the relative humidity of said gas stream, and
b) compelling said gas stream to interact with a solid surface.

2. The process of claim 1 wherein said solid surface is inside an enclosure.

3. The process of claims 1 and 2 wherein said enclosure has an inlet means for admitting said gas stream into said enclosure.

4. The process of Claims land 2 wherein said enclosure has an outlet means for allowing said gas stream to exit said enclosure.

5. The process of claim 1 wherein said solid surface is cooled by a cooling means to keep the temperature of said solid surface from exceeding the dew point temperature of said gas stream.

6. The process of claim 1 wherein said solid surface is cleaned of condensate and collected particulates by a cleaning means.
